(19) United States
(12) Patent Application Publication
(10) Pub. No.: US 2020/0312504 A1
(43) Pub. Date: Oct. 1, 2020

(54) MAGNETORHEOLOGICAL FLUID COMPOSITION

(71) Applicant: SOMAR CORPORATION, Tokyo (JP)

(72) Inventors: Hirohisa Ishizaki, Tokyo (JP); Akira Ochiai, Tokyo (JP)

(21) Appl. No.: 16/825,345

(22) Filed: Mar. 20, 2020

(30) Foreign Application Priority Data
Mar. 28, 2019 (JP) 2019-62625

(51) Int. Cl. H01F 1/44

(52) U.S. Cl. CPC H01F 1/447

(57) ABSTRACT

A magnetorheological fluid composition with excellent dispersion stability of magnetic particles and fluidity is provided. The magnetorheological fluid composition comprises magnetic particles, a dispersion medium, a viscosity modifier and hollow particles. The hollow particles preferably have an average primary particle diameter of 5 to 500 nm. The hollow particles are preferably at least one kind selected from a group consisting of carbon particles, silica and crosslinked styrene-acryl. The viscosity modifier is preferably at least one kind selected from a group consisting of castor oil, fatty acid amides, polyolefins and (meth)acrylate esters.

### BACKGROUND OF THE INVENTION

### Field of the Invention

The present invention relates to a magnetorheological fluid composition and particularly relates to a magnetorheological fluid composition used for controlling a frictional force acting between objects in various mechanical devices, such as dampers of a brake, clutch, antivibration device and damping device.

### Description of the Related Art

Generally, a magnetorheological fluid is prepared by dispersing magnetic particles, which are magnetizable metal particles in a dispersion medium. A magnetorheological fluid functions as a fluid when free from an influence of a magnetic field. On the other hand, when a magnetic field acts, it shows a characteristic that the magnetic particles form clusters and thicken, so that an internal stress increases.

Since a specific gravity of magnetic particles and that of dispersion medium are largely different in a magnetorheological fluid, the magnetic particles sediments easily. Also, hard slurry deposit is generated due to a cohesive force of the magnetic particles.

In this case, it leads to a decline of an internal stress of the fluid when a magnetic field acts, so that there are demands for an improvement of dispersion stability and suppression of sedimentation of the magnetic particles. Also, satisfactory fluidity as a fluid has to be secured, as well.

The followings are known as examples, which have improved those points (refer, for example, to patent documents 1-2). The patent document 1 is an example of using clay minerals, such as organic bentonite and organic hectorite. The patent document 2 is an example of using Neuburger siliceous earth.

All of the organic bentonite, organic hectorite and Neuburger siliceous earth used in the patent documents 1 and 2 are added as a thickener, but are not yet satisfactory enough in terms of dispersion stability and fluidity.

### RELATED ART DOCUMENTS

### Patent Documents

[Patent Document 1] Japanese Patent Unexamined Publication (Kokai) No. 2002-121578
[Patent Document 2] Japanese Patent Unexamined Publication (Kokai) No. 2006-286890

### SUMMARY OF THE INVENTION

In consideration of the above circumstances, an object of the present invention is to provide a magnetorheological fluid composition with excellent dispersion stability of magnetic particles and fluidity.

The present inventors found that the objects above can be achieved by including a viscosity modifier and hollow particles in a magnetorheological fluid composed of magnetic particles and dispersion medium and completed the present invention.

Namely, the magnetorheological fluid composition of the present invention comprises (A) magnetic particles, (B) a dispersion medium, (C) a viscosity modifier and (D) hollow particles.

Preferably, an average primary particle diameter of the hollow particles is in a range of 5 to 500 nm. The hollow particles are preferably at least one kind selected from a group consisting of hollow carbon particles, hollow silica particles and hollow crosslinked styrene-acrylic particles.

Also, the viscosity modifier is preferably at least one kind selected from a group consisting of castor oil, fatty acid amides, polyolefins, (meth)acrylate esters.

The present invention provides a magnetorheological fluid composition with excellent dispersion stability of magnetic particles and fluidity.

### BRIEF EXPLANATION OF DRAWINGS

FIG. 1 is an electronic microscope photography of (a1) carbonyl iron used as (A) magnetic particles in Examples, taken by a scanning electronic microscope (magnification of 45,000).

FIG. 2 is an electronic microscope photography of a solid component after removing a dispersion medium from a magnetorheological fluid composition of comparative example 1, taken by a scanning electronic microscope (magnification of 20,000).

FIG. 3 is an electronic microscope photography of a solid component after removing a dispersion medium from a magnetorheological fluid composition of example 1 taken by a scanning electronic microscope (magnification of 100,000).

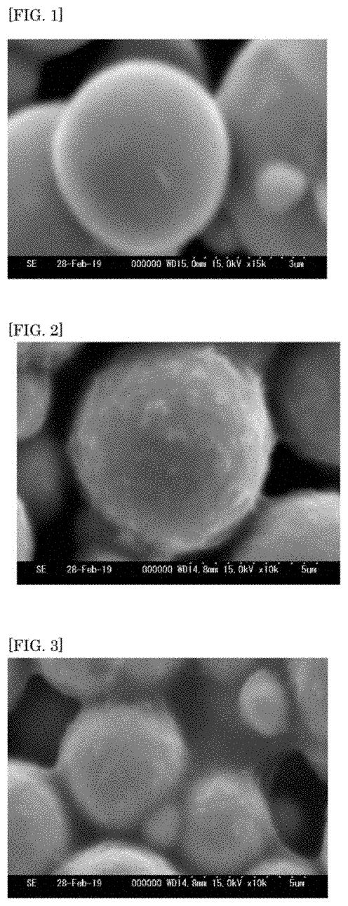

### DETAILED DESCRIPTION OF THE INVENTION

Below, the magnetorheological fluid composition of the present invention will be explained in detail.

Note that, in the present specification, “to” indicating a range of a value means a range including the indicated upper-limit value and the lower-limit value. Also, when unit is added only to the upper-limit value in a range of a value, it means that the lower-limit value is in the same unit.

In graded value ranges in the present specification, an upper-limit value or lower-limit value described in a certain value range may be replaced by upper-limit values or lower-limit values of other graded value ranges.

Also, in value ranges described in the present specification, an upper-limit value or lower-limit value described in a certain value range may be replaced by values indicated in examples.

In the present specification, a content ratio or a content of each component in a composition means, in the case where there are a plurality of substances falling under respective components in the composition, a content ratio or a content of a total of the plurality of substances existing in the composition unless otherwise mentioned.

### (Magnetorheological Fluid Composition)

The magnetorheological fluid composition of the present invention comprises (A) magnetic particles, (B) a dispersion medium, (C) a viscosity modifier and (D) hollow particles.

Generally, it is a colloidal fluid, wherein magnetic particles are dispersed in a dispersion medium.

The magnetorheological fluid composition of the present invention exhibits suppressed sedimentation of magnetic particles and has excellent fluidity as a result of comprising (A) magnetic particles, (B) a dispersion medium, (C) a viscosity modifier and (D) hollow particles.

The reason is considered as below.

When comparing FIG. 2 with FIG. 3, despite that FIG. 3 has magnification of 5 times larger, it shows the state that hollow particles are hard to see, which is considered because magnetic particles integrated with hollow particles are covered with a viscosity modifier. Therefore, detachment of hollow particles from magnetic particles is suppressed. As a result, it is considered that sedimentation of the magnetic particles is suppressed and dispersion stability and fluidity are improved.

Below, respective components included in the magnetorheological fluid composition will be explained.

### (A) Magnetic Particles

The magnetorheological fluid composition of the present invention comprises magnetic particles, which can be selected in accordance with an aimed magnetic permeability. For example, magnetite, carbonyl iron, γ-iron oxide, manganese ferrite, cobalt ferrite, or complex ferrites of the above with zinc or nickel, barium ferrite and other ferromagnetic oxides; iron, cobalt, rare earths and other ferromagnetic metals; metal nitrides; Sendust (registered trademark), Permalloy (registered trademark), supermalloy (registered trademark) and other variety of alloys, etc. may be mentioned. Among them, carbonyl iron is preferable in terms of being a soft magnetic material having a small coercive force and large magnetic permeability.

As the magnetic particles, one kind may be used alone or two or more kinds may be used in combination

In the magnetorheological fluid composition of the present invention, when a magnetic field is applied from outside, dispersed magnetic particles orients to the direction of the magnetic field and form chained clusters so as to be thickened, and a fluidity characteristic and sedimentation stress thereof change. An average particle diameter of the magnetic particles is determined so as to exhibit such behaviors. Specifically, it is preferably in a range of 0.1 to 100 μm, more preferably 1 to 60 μm and particularly preferably 5 to 50 μm. A shape of the magnetic particles is preferably sphere or nearly sphere so as to be dispersed easily.

Note that an average particle diameter of the magnetic particles is an average primary particle diameter measured by a laser diffraction/scattering grain size distribution measuring apparatus.

A content ratio of the magnetic particles is, with respect to a total amount of the magnetorheological fluid composition of the present invention, preferably in a range of 30 to 90 weight % and more preferably 40 to 80 weight %. When the content ratio of the magnetic particles with respect to the total amount of the magnetorheological fluid composition of the present invention is 30 to 90 weight %, it exhibits a necessary shearing stress and functions as a fluid.

### (B) Dispersion Medium

The magnetorheological fluid composition of the present invention comprises a dispersion medium. There is no particular limit as far as it is in a liquid state at the normal temperature (25° C.) and allows magnetic particles to be dispersed therein. For example, α-olefins, isoparaffin, normal paraffin, halogenated hydrocarbon and other hydrocarbon-based solvents, ester-based solvents, glycol-based solvents and silicon-based solvents may be mentioned. As α-olefins, 1-hexane, 1-octene, 1-decene, 1-dodecene, 1-tetradecene, 1-hexadecene and 1-octadecene, etc. may be mentioned. Among them, 10-14C α-olefins, such as 1-octene, 1-decene and 1-dodecene, are preferable. As glycol-based solvents, polyethylene glycol, polypropylene glycol, polybutylene glycol or ethylene oxide-propylene oxide copolymer, propylene oxide-butylene oxide copolymer and derivatives of the above may be mentioned.

As the dispersion medium, one kind may be used alone or two or more kinds may be used in combination if they have good compatibility.

Kinematic viscosity of the dispersion medium at 40° C. is preferably in a range of 2 to 5000 mm²/s, more preferably 5 to 2000 mm/s and furthermore preferably 5 to 1000 mm²/s. When the kinematic viscosity of the dispersion medium at 40° C. is 2 to 5000 mm²/s, a clash point of the dispersion medium becomes high, evaporation is suppressed and magnetic particles are dispersed easily in the dispersion medium. Note that kinematic viscosity is a value measured according to determination of kinematic viscosity in JIS K2283:2000.

The content ratio of the dispersion medium with respect to a total amount of the magnetorheological fluid of the present invention is preferably 5 to 30 weight % and more preferably in a range of 9 to 25 weight %.

### (C) Viscosity Modifier

The magnetorheological fluid composition of the present invention comprises a viscosity modifier. For example, castor oil, hydrogenated castor oil, fatty acid amide, beeswax, carnauba wax, benzylidene sorbitol, metallic soap, polyethylene oxides, sulfate-based anionic surfactants, polyolefins, (meth)acrylate esters, polyisobutylene, ethylene-propylene copolymers and polyalkyl styrene, etc. may be mentioned.

Among them, castor oil, fatty acid amides, polyolefin, (meth)acrylate esters are preferable in terms of exhibiting excellent effects of suppressing sedimentation of magnetic particles and making viscosity adjustment of the magnetorheological fluid composition easy.

As the viscosity modifier, one kind may be used alone or two or more kinds may be used in combination.

As the fatty acid amides, for example, stearic acid amide, oleic acid amide, erucic acid amide, methylene bis-stearic amide and ethylene bis-stearic amide, etc. may be mentioned. Among them, stearic acid amide and oleic acid amide are preferable. As the fatty acid amides, one kind may be used alone or two or more kinds may be used in combination.

Polyolefin preferably has the number average molecular weight in a range of 2000 to 7000. When in the range above, an excellent effect of suppressing sedimentation of magnetic particles can be obtained and viscosity of the magnetorheological fluid composition can be adjusted easily, which are preferable.

A content ratio of the viscosity modifier with respect to a total amount of the magnetorheological fluid composition is preferably in a range of 0.5 to 10 weight % and more preferably 0.7 to 9 weight %. When the content ratio of the viscosity modifier with respect to the total amount of the magnetorheological fluid composition is in the range of 0.5 to 10 weight %, sedimentation of magnetic particles can be suppressed and fluidity can be secured.

### (D) Hollow Particle

The magnetorheological fluid composition of the present invention comprises hollow particles. For example, hollow carbon particles, hollow silica particles, hollow crosslinked styrene acrylic particles, etc. may be mentioned. Among them, hollow carbon particles are preferable. Note that the hollow particle indicates a particle having a hollow structure. The hollow structure is referred to as the concept including the structure of being covered with a shell and having complete hollow inside as well as a porous structure, wherein trench-shaped cavities reaching to inside the particle are formed.

Examples of the hollow carbon particles are carbon particles obtained by pyrolyzing lignin (hereinafter, also referred to as “Lignin Black (registered trademark)”), Ketjenblack (registered trademark), which is hollow carbon black, carbon nano balloon and nano porous carbon, etc.

The Lignin Black is available on market as, for example, Lignin Black (produced by Daio Paper Corporation).

Ketjenblack is available on market as, for example, Ketchenblack EC300J and EC600JD (produced by Lion Specialty Chemicals Co., Ltd.), etc.

The Nano porous carbon is available on market as, for example, NPC-H, NPC-L and NPC-N (produced by Neomond Ltd.), etc.

The hollow silica particles are available on market and SiliNax (registered trademark) (produced by Nittetsu Mining Co., Ltd. and having an average primary particle diameter of 100 nm), etc. may be mentioned.

The hollow crosslinked styrene acrylic particles are available on market as, for example, SX866 and SX868 (produced by JSR Corporation and having an average primary particle diameter of 300 nm and 500 nm, respectively), etc.

As the hollow particles, one kind may be used alone or two or more kinds may be used in combination.

The average primary particle diameter of the hollow particles is preferably in a range of 5 to 500 nm. The lower limit value is more preferably 10 nm and particularly preferably 20 nm. The upper limit value is more preferably 300 nm and particularly preferably 100 nm. When the primary particle diameter of the hollow particles is in the range of 5 to 500 nm, sedimentation of magnetic particles can be suppressed and detachment of hollow particles from magnetic particles can be suppressed. Note that an average particle diameter of the hollow particles means an average outer diameter unless otherwise mentioned.

A content ratio of the hollow particles with respect to a total amount of the magnetorheological fluid composition is preferably in a range of 0.2 to 0.8 weight % and more preferably 0.3 to 0.7 weight %. When the content ratio of the hollow particle with respect to the total amount of the magnetorheological fluid composition is in a range of 0.2 to 0.8 weight %, a magnetorheological fluid composition having excellent dispersion stability and fluidity can be obtained.

### (Other Components)

Other than the components above, the magnetorheological fluid composition of the present invention may furthermore comprise a variety of other components in accordance with the purpose within a range of not undermining the effects of the invention. As other components, for example, fine magnetic particles, a dispersant, pour point depressant, extreme pressure agent, rust preventive, antioxidant, corrosion inhibitor, metal inactive agent and defoaming agent, etc. may be mentioned.

As the fine magnetic particles, those having the same material composition as the magnetic particles explained above may be used and the average particle diameter is 5 to 50 nm and more preferably 7 to 40 nm.

An average particle diameter of the fine magnetic particles is an average primary particle diameter measured by the dynamic light scattering method.

A dispersant is added to improve dispersibility of the magnetic particles in the dispersion medium. As the dispersant, well-known surfactants and polymer dispersants may be used arbitrarily. Among them, surfactants are preferable in terms of dispersibility.

As the surfactant to be used as the dispersant, for example, petroleum sulfonates or sodium thereof, synthetic sulfonates or sodium thereof, eicosyl naphthalenesulfonic acid or sodium thereof, polybutene succinate or sodium thereof, erucic acid or sodium thereof and other anionic surfactants as hydrocarbon compounds having polar group, such as a carbokyl group, hydroxyl group and sulfonate group; polyoxyalkylene lauryl ether, polyoxyalkylene decyl ether, polyoxyalkylene isodecyl ether, polyoxyalkylene tridecyl ether, polyoxyethylene lauryl ether, polyoxyethylene decyl ether, polyoxyethylene isodecyl ether, polyoxyethylene tridecyl ether, polyoxyethylene alkyl ether, polyoxyethylene nonylphenyl ether and other nonionic surfactants; and alkyldiamino ethylglycine and other amphoteric surfactants, wherein the molecular structure has both of a cation part and anion part; etc. may be mentioned.

As the surfactant, one kind may be used alone or two or more kinds may be used in combination.

### (Production Method of Magnetorheological Fluid Composition)

The production method of the magnetorheological fluid composition of the present invention is not particularly limited. For example, there is a method of mixing magnetic particles, a dispersant, a viscosity modifier, hollow particles and other components to be added as desired by using a processor capable of giving a high shearing force, such as a homogenizer, bead mill and mechanical mixer. In producing a magnetorheological fluid, it may be heated or cooled when required.

### EXAMPLES

Below, the present invention will be explained more in detail with examples.

### Examples 1-3 and Comparative Examples 1-4

Respective components at the weight ratios as shown in Table 1 were put in a beaker, heated at 80° C. for 10 minutes, after that, agitated at 100 rpm for 1 minute by using a homogenizer so as to produce magnetorheological fluid compositions. Each of the obtained magnetorheological fluid compositions in an amount of 25 ml was put in a sample bottle No. 7 (produced by As One Corporation, 50 ml) and dispersion stability and fluidity were evaluated.

The evaluation methods will be explained later on.

The followings are the used materials.

### (A) Magnetic Particles

(a1) carbonyl iron (spherical particles, D₅₀=8 μm)

### (B) Dispersion Medium

(b1) polyalkylene glycol (kinematic viscosity of 30 mm²/is 40° C.)

(b2) α-olefin (kinematic viscosity of 15 mm²/s, 40° C.)

### (C) Viscosity Modifier

(c1) castor oil

(c2) stearic acid amide

### (D) Hollow Particles

(d1) hollow carbon particles (Ketjenblack EC300J, average primary particle diameter of 39 nm, produced by Lion Specialty Chemicals Co., Ltd.)

Other Component

Dispersant: polyoxyalkylene decyl ether

### <Evaluation of Dispersion Stability>

A magnetorheological fluid composition was put in a sample bottle and, after 240 hours at 23° C., a thickness of a magnetic particle containing layer and that of a dispersion medium layer (supernatant layer) were measured. A thickness of the dispersion medium layer with respect to a total thickness of the magnetic particle containing layer and the dispersion medium layer was expressed in percentage (a separation rate), which was used as an evaluation value. The obtained results are shown in Table 1. Note that the separation rate is preferably 10% or less, more preferably 5% or less and particularly preferably 3% or less.

### <Evaluation of Fluidity>

The magnetorheological fluid after 240 hours used in the evaluation of dispersion stability above was inclined by 45 degrees and fluidity of the magnetic fluid was evaluated. The evaluation criteria are as below.

A: those flew 10 mm or more when inclined for 10 seconds

B: those flew 10 mm or more when inclined for 20 seconds (except for samples evaluated as A)

C: those flew less than 10 mm when inclined for 20 seconds

D: those did not flow when inclined for 20 seconds

TABLE 1

| | | | | | Comparative | Comparative | Comparative | Comparative |
|---|---|---|---|---|---|---|---|---|
| | | Example 1 | Example 2 | Example 3 | Example 1 | Example 2 | Example 3 | Example 4 |
| (A)Magnetic | (a1) Carbonyl Iron | 20 | 20 | 20 | 20 | 20 | 20 | 20 |
| Particles | | | | | | | | |
| (B)Dispersion | (b1) Polyalkylene Glycol | 4 | 4 | 4 | 4 | 4 | 4 | 4 |
| Medium | (b2) α -Olefin | 1 | 1 | 1 | 1 | 1 | 1 | 1 |
| (C)Viscosity | (c1) Castor Oil | 0.25 | 2.25 | — | — | 0.25 | — | 2.25 |
| Modifier | (c2) Stearic Acid Amide | — | — | 0.25 | — | — | — | — |
| (D)Hollow | (d1) Hollow Carbon Particle | 0.06 | 0.15 | 0.06 | 0.06 | — | 0.15 | — |
| Particles | | | | | | | | |
| Dispersant | Polyoxyalkylene Decyl Ether | 0.5 | 0.5 | 0.5 | 0.5 | 0.5 | 0.5 | 0.5 |
| Evaluation | Dispersion Stability (%) | 0 | 0 | 0 | 0 | 20 | 0 | 30 |
| Results | Fluidity (45° Inclination) | A | A | A | D | A | D | A |

As shown in Table 1, comparative examples 1 and 3 not comprising any (C) viscosity modifier exhibited preferable dispersion stability but did not have fluidity. Also, comparative examples 2 and 4 not comprising any hollow particles obtained fluidity but had poor dispersion stability. On the other hand, examples 1-3 comprising all of (A) magnetic particles, (B) a dispersion medium, (C) a viscosity modifier and (D) hollow particles satisfied both of dispersion stability and fluidity, and the effects of the present invention were confirmed.

1. A magnetorheological fluid composition comprising (A) magnetic particles, (B) a dispersion medium, (C) a viscosity modifier and (D) hollow particles.

2. The magnetorheological fluid composition according to claim 1, wherein an average primary particle diameter of the hollow particles is in a range of 5 to 500 nm.

3. The magnetorheological fluid composition according to claim 2, wherein the hollow particles are at least one kind selected from a group consisting of carbon particles, silica and crosslinked styrene-acryl.

4. The magnetorheological fluid composition according to claim 3, wherein the (C) viscosity modifier is at least one kind selected from a group consisting of castor oil, fatty acid amides, polyolefins and (meth)acrylate esters.

5. The magnetorheological fluid composition according to claim 1, wherein the hollow particles are at least one kind selected from a group consisting of carbon particles, silica and crosslinked styrene-acryl.

6. The magnetorheological fluid composition according to claim 1, wherein the (C) viscosity modifier is at least one kind selected from a group consisting of castor oil, fatty acid amides, polyolefins and (meth)acrylate esters.

7. The magnetorheological fluid composition according to claim 2, wherein the (C) viscosity modifier is at least one kind selected from a group consisting of castor oil, fatty acid amides, polyolefins and (meth)acrylate esters.
